(19) United States
(12) Patent Application Publication
(10) Pub. No.: US 2005/0214465 A1
(43) Pub. Date: Sep. 29, 2005

(54) Method for producing composite materials using a thermoplastic matrix

(76) Inventors: Peter Maskus, Domat/Ems (CH); Christian Kruse, Trubbach (CH); Eduard Schmid, Bonaduz (CH); Anreas Mettier, Landquart (CH); Jonny Lohmiller, Horb (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/499,032

(22) PCT Filed: Dec. 17, 2002
(86) PCT No.: PCT/CH02/00703

§ 371 Date: May 10, 2005

(30) Foreign Application Priority Data
Dec. 20, 2001 (CH) 2348/01

(51) Int. Cl. B05D 3/02

(52) U.S. Cl. 427/372.2

(57) ABSTRACT

The invention relates to a method for producing a composite material (33) consisting of reinforcing elements (29) and a thermoplastic polyamide, said method permitting high-speed production with continuous process control, using simple equipment. The method is characterized by the following steps: the supplied reinforcing elements (29) are impregnated with a lactam melt (11) that is activated for anionic polymerization, at a temperature at which the activated lactam melt (11) does not polymerize; the impregnated reinforcing element (30) is heated and polymerized in a heating unit (17) without passing through a heated die and in an essentially contactless manner; the resultant hot polymerized composite material (31) is cooled in a cooling unit (18). The lactam melt (11) that is activated for anionic polymerization is produced by first melting the lactam or more precisely the mixture of lactams to obtain a monomer melt (3) and a liquid initiator (6) is added to the monomer melt (3) immediately prior to the impregnation process of the reinforcing element (29), said liquid initiator (6) containing simultaneously the activator and the catalyst function in solute form.

### TECHNICAL FIELD

The present invention relates to a method for the production of a composite from reinforcing materials and a thermoplastic polyamide as matrix.

### PRIOR ART

For the production of composites from reinforcing materials and a thermoplastic polyamide as matrix use is made, on the one hand, of methods in which the monomer is polycondensed, and, on the other, of anionic polymerization, which takes place in the absence of water. In this process the anionic polymerization of lactams is catalyzed by lactamate, and can additionally be started by the use of so-called activators, e.g. in the form of acyllactams or of isocyanates (activated anionic polymerization, cf. e.g. Kunststoff-Handbuch, Volume 3/4 Technische Thermoplaste Polyamide, edited by Ludwig Bottenbruch and Rudolf Binsack, Carl Hanser Verlag, Munich and Vienna, 1998, in particular pages 48 et seq.). Compared with hydrolytic polymerization the activated anionic polymerization of lactams has the advantage of a higher reaction rate, and therefore in principle offers the possibility of higher production rates.

The production of semifinished goods, hollow articles, organometal sheets, profiles etc. with fiber-reinforced braids, nonwoven fabrics, woven fiber or filament fabrics or rovings and a thermoplastic matrix using polyamide usually takes place in a so-called pultrusion process, in which the reinforcing material impregnated or saturated with monomer or pre-polymer for polymerization is put immediately after impregnation into a mold or pulled through a mold, respectively, which is kept at a temperature at which the polymerization occurs completely, and in which the final shape of the article to be produced is created under pressure (cf. e.g. “Einführung in die Technologie der Faserverbundwerkstoffe”, edited by W. Michaeli et al., Carl Hanser Verlag, 1989). In connection with the pultrusion of reinforced thermoplastic parts, which unlike thermosetting plastic parts have inter alia the advantage of being thermoplastically reworkable, there is in principle the problem that polymer melts of thermoplastic materials usually exhibit low flowability at melting point (high viscosity), and the matrix is solid at room temperature. In order to be able to work with a pultrusion method using thermoplastic materials in spite of this, higher temperatures are usually needed for the impregnation/saturation of the fibers or the like used for reinforcement (with the upper limit of the temperature being of course determined by the temperature at which the polymer decomposes), but even then, as a result of the high viscosity, there is the problem that when the impregnated reinforcing material is introduced into the pultrusion mold a considerable buildup and backflow of the melt arises at the entry into the mold (so-called “bird's nest”, cf. e.g. “Kunststoffe”, 88 (1998) 5, pages 485 et seq., Carl Hanser Verlag, Munich), with which even fibers of the reinforcing materials can be entrained, and in the worst case can even be obstructed as a result of the decrease in the temperature of the melt at the entry thereof. The melt backflow and the high viscosity of the melt (together with the high shearing forces to which the mold is exposed) as a rule limit the rate of the production process, since the latter has to be adapted to the possible tensile force at the end of the production process, which is essentially determined by the tensile stability of the reinforcing materials (cf. e.g. “Processing of continuous fibre reinforced thermoplastics”, by Prof. A. G. Gibson, paper given at the “7th Lausanne Polymer Meeting, Processing and Properties of Thermoplastic Matrix Composites, Lausanne, Jul. 21-22, 1992, organized by the Ecole Polytechnique Fédérale de Lausanne (EPFL)”). Whereas pulling speeds of up to 3 m/min are possible in the pultrusion of thermosetting plastics (cf. e.g. “Einführung in die Technologie der Faserverbundwerkstoffe”, edited by W. Michaeli et al., Carl Hanser Verlag, 1989), only significantly lower pulling speeds are possible when thermoplastics with polyamide as matrix are used. Higher pulling speeds are only possible with methods where the reinforcing yarn is already premixed with polymer fibers (e.g. hybrid yarn).

EP 0544049 A1 describes a pultrusion process by the so-called 2-pot method, in which anionically activated lactam melt is used to impregnate the fibers, and the temperature in the tool, i.e. in the mold, is raised to at least the melting range of the polyamide (polyamide-6). This is intended to lead to improved properties and an improved surface of the pultrusion profile. In this operation the lactam melt is prepared in such a way that a first part of the lactam melt is mixed with catalyst and in another tank the second part of the lactam melt is mixed with activator. The two melts are brought together and mixed just before the impregnation process. The mold used for pultrusion in this document is described in U.S. Pat. No. 4,635,432, and is a tubular body whose internal diameter corresponds to the desired external diameter of the pultrudate. With regard to short molds, in particular, reference is made in this document to the problem of dripping of melt, and it-is suggested that the mold be made at least 15 to 30 times as long as the diameter of the pultrudate.

U.S. Pat. No. 5,424,388 also describes the pultrusion of moldings using activated anionic lactam melt in the 2-pot method, where the reinforcing material fed in is impregnated with the melt and immediately afterward pulled into a hot mold, in which the matrix polymerizes completely. Reference is made to a maximum possible pulling speed of less than 0.5 m/min.

Apart from the 2-pot method, as described in EP 0544049 A1 and in U.S. Pat. No. 5,424,388, there is also the possibility of working with liquid initiators which contain a liquid catalyst and an activator (so-called 1-pot method). EP 0791618 A1 describes for example a method for the production of thermally remoldable composites with a lactam matrix using activated anionic polymerization, where the lactam melt has a liquid initiator added to it just before the impregnation of a reinforcing material, and is mixed with the activated anionic lactam melt, the liquid initiator containing both the catalyst and the activator in dissolved form. In this connection EP 0872508 A1 describes in particular liquid initiators which are stable when stored at room temperature and are suitable for anionic lactam polymerization. Other possible systems of liquid initiators are described in both documents of the applicant DE 19961818 A1 and DE 19961819 A1, where in the liquid system the catalyst and the activator are not separate, but instead to a certain extent one unit can assume or inherently possesses both functions, and both functions are made available on mixing with lactam. In this connection mention should also be made of DE 19527154 C2, which proposes methods for the production of thermoplastically deformable composites, using anionic activated lactam polymerization. Here again use is made of the 2-pot method or a powder mixing method, and the impregnation of the fibers takes place at a temperature at which a so-called prepolymer stage is established, i.e. the operation is performed in a temperature range in which the liquid lactam melt changes directly into the liquid polymer melt on impregnation.

### DESCRIPTION OF THE INVENTION

The object of the invention is accordingly to provide a method for the production of a composite, consisting of reinforcing materials and a thermoplastic polyamide, which is simple, i.e. can be carried out with a simple device, and which permits high process speeds in the continuous production method, especially in the case of raw, i.e. not pre-impregnated, reinforcing materials. This using activated anionic lactam polymerization. The umbrella term “polyamide” here means homopolyamides, copolyamides and mixtures thereof.

This object is achieved by using a method with the following steps:
the reinforcing materials supplied are impregnated with a lactam melt activated for anionic polymerization, this being at a temperature at which the activated lactam melt does not significantly polymerize yet,
the impregnated reinforcing material is then heated and polymerized in a heating unit, without going through a heated or unheated mold, with the impregnated reinforcing material being passed through the heating unit without any significant contact,
the resultant hot polymerized composite is then cooled in a cooling unit,
   where the lactam melt activated for anionic polymerization is produced by first melting the lactam or the mixture of lactams to form a monomer melt, and mixing a liquid initiator with the monomer melt essentially just before the process of impregnation of the reinforcing material, which liquid initiator simultaneously contains the activator function and the catalyst function in solution.

The core of the invention thus consists on the one hand in completely dispensing with the use of an actual pultrusion mold, i.e. of an actual molding tool. As already mentioned above, the use of a pultrusion mold greatly limits the possible pulling speeds. Surprisingly it now turns out that a pultrusion mold can be completely dispensed with, i.e. it is possible to run the impregnated reinforcing material essentially directly into a heating unit in which the matrix completely polymerizes at the corresponding temperature. Profiling of the strand, which may be necessary in some cases, can optionally be carried out after the polymerization by thermoplastic deformation (e.g. roll forming). The high tensile forces, or friction or braking forces, which arise when a pultrusion mold is used can in this way be completely avoided, thus allowing significantly higher production rates.

According to the prior art the activated lactam melt is usually produced in the so-called 2-pot method, i.e. the lactam melt activated for anionic polymerization is produced using two separate lactam melts, one of which contains the catalyst and the other the activator, and which are brought together and thoroughly mixed essentially just before the process of impregnation of the reinforcing material. One problem in such a method is the fact that the two pots containing lactam melts, which of necessity are kept at the melting point of the monomer, have a tendency already to polymerize or react in some other way as a result of the presence of the activator or catalyst. This 2-pot method is thus unsuitable for continuous processes, since in these the pots have to be kept ready the whole time. According to the present invention, however, the lactam melt activated for anionic polymerization is now produced by first melting the lactam or the mixture of lactams to form a monomer melt, if necessary with the addition of fillers or other additives (e.g. heat and UV stabilizers or coloring agents), and mixing a liquid initiator with the monomer melt, essentially not until just before the process of impregnation of the reinforcing material, which liquid initiator simultaneously contains the activator function and the catalyst function in solution, and which liquid initiator is in particular, but not necessarily, stable in storage and liquid at room temperature. Only this surprisingly simple implementation of the process, with separate provision of a monomer melt that is stable in storage and a liquid initiator, which assumes both the catalyst function and the activator function, with the monomer melt and the liquid initiator not being mixed until just before the impregnation, permits a continuous, economic process in which the abovementioned problems can be avoided, since the monomer melt, kept at the melting point and if necessary under an inert gas (e.g. dry nitrogen), is stable in storage without the addition of catalyst or activator.

In order to achieve a high production rate, highly reactive initiators or activators must be used, which for the abovementioned reasons should be kept separate from the lactam melt and not brought into contact with the lactam melt until just before use—which in practice is technically and economically feasible only with the 1-pot method.

The lactam melt used in the present invention, activated for anionic polymerization, is essentially a melt consisting of aliphatic lactam, in particular preferably of butyrolactam, valerolactam, caprolactam, enantholactam or laurolactam, or of a mixture of said lactams, with the lactam melt containing a liquid initiator with catalyst and activator function in solution. With regard to the mixtures preference is given to the one consisting of caprolactam and laurolactam which gives rise to copolyamide-6/12 by polymerization.

Liquid systems such as described in EP 0791618 A1 or in EP 0872508 A1 can in particular be used as the liquid initiator. With regard to the liquid initiator the disclosure content of both these documents should be explicitly included in the disclosure content of this document.

According to a further preferred embodiment the liquid initiator contains a catalyst in the form of an alkali metal, a tetraalkylammonium or alkaline earth metal lactamate, in particular of a sodium or potassium lactamate, with lactamates having 5 to 13 ring members, preferably lactamates having 5 to 7 ring members, and more preferably caprolactamate, being used.

According to another preferred embodiment the liquid initiator contains an activator activating the anionic polymerization in the form of an acyllactam, of a carbodiimide, of a polycarbodiimide, of a monoisocyanate, and/or of a diisocyanate, and/or in the form of a mixture of these activators, with the activators preferably being masked with lactam or hydroxy-fatty alkyloxazolines.

Another preferred embodiment is characterized in that in the liquid initiator the catalyst and activator function is assumed by at least one initiator component in dissolved form, which initiator component in a free or partially to completely inherent way exhibits the necessary structural elements to form the catalyst and the activator on contact with lactam. Such a structure can in particular be provided when the initiator component is a product of the reaction of isocyanate and/or of carbodiimide with a protic compound and a base in an aprotic solvation medium. In other words the liquid initiator can for example be a system such as described in the applicant's documents DE 19961818 A1 and DE 19961819 A1. With regard to the liquid initiator the disclosure content of both these documents should be explicitly included in the disclosure content of the present application.

The adjustment of the liquid initiator content of the lactam melt activated for anionic polymerization, as used for the impregnation, is performed in such a way that the polymerization in the heating unit takes place essentially completely, i.e. at the temperature prevailing there within the period of passage through the heating unit. For this purpose the liquid initiator is usually mixed with the monomer melt in an amount of 1 to 10% by weight, in particular 2 to 4% by weight, relative to 100% activated anionic lactam melt. The proportional amount also depends on the reactivity of the activator.

A further preferred embodiment consists in the fact that the lactam melt activated for anionic polymerization additionally contains fillers or other additives, e.g. heat and UV stabilizers or coloring agents. Heat stabilizers are also called antioxidants here.

The reinforcing materials comprise a diverse range of structures, such as for example glass fibers, carbon fibers, aramid fibers, high-temperature polyamide fibers, metal fibers or combinations of said fibers (e.g. in the form of wound continuous filaments, yarns, staple fiber yarns, strands such as rovings, etc.), and/or textile products formed from said fibers (e.g. mats, needled felt, etc., or woven textiles such as knitted fabrics, woven fabrics, braids, stitched fabrics, nonwoven fabrics, etc.) or from combinations of said fibers and/or said textile products. The method according to the invention is found to be particularly suitable for fibers or, in general, reinforcing materials which are brittle, friable and/or high-modulus (e.g. carbon fibers) and corresponding textile products where application of pressure during impregnation and/or shear in highly viscous melts (in a pultrusion mold) leads to considerable fiber damage (fiber breakage). Through the rapid and pressure-free coating with a monomer melt and the free polymerization without application of force one obtains undamaged composites of high quality.

In a further preferred embodiment the reinforcing material is dried and/or preheated before the impregnation, e.g. in a preheating unit, the preheating being in particular to a temperature which lies above the melting point of the lactam melt activated for anionic polymerization. The preheated reinforcing material can be impregnated or saturated especially well with melt, e.g. in an immersion bath, if necessary using several squeeze/immersion cycles, or in a hollow profile with a skimming point.

According to a further preferred embodiment of the method according to the invention the reinforcing material is continuously passed through the preheating unit in the form of one or more sheets or filaments, if necessary conveyed with tension-regulated feed rollers, impregnated with the lactam melt activated for anionic polymerization, passed through the heating unit and cooling unit, and drawn off by withdrawal devices downstream of the cooling unit. The withdrawal devices can be rollers, crawlers, pulling devices with clamps, or winders. The composite can in this way preferably be advanced through the process with a speed of at least 1 m/min, in particular of at least 5 m/min. Speeds of over 10 m/min are particularly preferred and economically very advantageous.

According to another preferred embodiment essential process steps take place under a protective gas atmosphere (in an inert gas atmosphere), in order to prevent oxidation of the lactam melt as far as possible. This means that the impregnated reinforcing material is conveyed under a protective gas atmosphere, in particular under a (dry) nitrogen atmosphere, at least in the heating unit, and that in a particularly preferred embodiment in addition the area in which the reinforcing material is heated up or dried, the area in which the impregnation takes place, and the tanks in which lactam melt and where appropriate even that of the liquid initiator and the cooling unit are kept, are kept under a protective gas atmosphere. A counterflow through the protective gas used is found to be advantageous especially in the heating unit and in the cooling unit, i.e. in the area where the reinforcing material is heated up, in the impregnation area and in particular in the area of the heating and cooling unit the protective gas is conveyed in counterflow to the process direction. The counterflow of the protective gas, in combination with the resultant slightly increased pressure on the material transported, leads to the effect that sublimation problems (sublimation of lactams and corresponding unwanted removal of monomer from the impregnated reinforcing material, as well as deposition of desublimated lactams on the walls confining the process, e.g. the channel in the form of a hollow profile) can be greatly reduced. The overflow of the impregnated reinforcing material obviously leads to reduced sublimation and/or to better removal of sublimate from the guide system. In particular when the blanketing with protective gas takes place to a certain extent from downstream of, first of all through the cooling unit, then through the heating unit, and at least as far as the area immediately downstream of the impregnation, a homogeneous, constant (i.e. balanced, not abrupt) temperature management (heating or cooling) can furthermore be guaranteed through this approach—which on the one hand is advantageous in terms of energy and, on the other, further reduces sublimate depositions. This approach is especially advantageous when using caprolactam, which has a significantly greater tendency to sublimation than laurolactam. In particular in order to prevent the volume blanketed with protective gas becoming too great, the whole process line (preheating unit, impregnation, heating and cooling unit) is advantageously designed in the form of a channel. This channel is adapted in its cross section to the cross section of the impregnated reinforcing material in such a way that sufficient free space all around is left between the impregnated reinforcing material and the channel walls, both for the (dry) nitrogen flowing through and also to convey the impregnated reinforcing material through the channel essentially without contact. The channel or the walls of the area passed through are preferably made of Teflon.

In order to prevent the entrainment of too great an amount of lactam melt, the impregnated reinforcing material can go past a skimming point at which excess lactam is skimmed off, essentially immediately after the impregnation and essentially before entry into the heating unit, in the process direction. Alternatively the lactam melt needed can also be supplied by means of a metering or regulating device (e.g. pump).

According to a particularly preferred embodiment the lactam used is laurolactam, which is melted, i.e. heated to above the melting point of 151 degrees Celsius (as a rule to about 170 degrees Celsius), a liquid initiator kept at room temperature is added to it, and it is mixed with the lactam melt activated for anionic polymerization. The continuously supplied reinforcing material, preheated to around 170 degrees Celsius, is impregnated at a temperature of around 170 degrees Celsius, completely polymerized freely and essentially without contact in the heating unit at a temperature in the range from 200 to 250 degrees Celsius for a time from 30 sec to 5 minutes, in particular for a time from 1 to 3 minutes, while being guided in a channel and under a protective gas atmosphere, and is then cooled in the cooling unit to a temperature of less than 150 degrees Celsius.

According to another particularly preferred embodiment the lactam used is caprolactam, which is melted, i.e. heated to above the melting point of 69 degrees Celsius (as a rule to about 170 degrees Celsius), a liquid initiator kept at room temperature is added to it, and it is mixed with the lactam melt activated for anionic polymerization. The continuously supplied reinforcing material, preheated to around 170 degrees Celsius, is impregnated at a temperature of around 170 degrees Celsius, polymerized completely freely and essentially without contact in the heating unit at a temperature in the range from 230 to 240 degrees Celsius for a time from 30 sec to 5 minutes, in particular for a time from 1 to 3 minutes, while being guided in a channel and under a protective gas atmosphere, and is then cooled in the cooling unit to a temperature of less than 200 degrees Celsius. It is also possible to operate the heating unit at a temperature below the melting point of polycaprolactam, i.e. below 222 degrees Celsius, and to run the polymerization at this lower temperature. The process then runs correspondingly slower, however, and requires longer passage through the heating unit, or else the reaction must be accelerated by an increased input of liquid initiator.

In the production of products with very large areas it may be advantageous to support the textile product to be impregnated by means of an accompanying conveyor belt and to take it in this way through the whole process line.

A further embodiment is characterized in that the composite polymerized completely is either processed in line, for example with methods such as roll forming or interval hot pressing, to give profiles, or is later subjected to thermoplastic posttreatment. In addition the composite polymerized completely can be made up into completely impregnated fiber composite semifinished goods (e.g. organometal sheets) which can then be pressed to make three-dimensional moldings. The complete fiber impregnation performed according to the invention offers the possibility of very short molding times and thus high economic efficiency. The production of long-fiber-reinforced granulate is also possible in this way, i.e. by cutting the composite strand that has been completely polymerized with the rotary knife of a granulator. Such a granulate can be further processed, for example by the injection molding or extrusion method, giving moldings with excellent mechanical properties. Used composites, however, can also be crushed later, have other substances added where appropriate, and be recycled by injection molding or pressing for example.

Further preferred embodiments of the method are described in the dependent claims. The semifinished product that has been made up can thus be further processed by thermoplastic posttreatment, preferably selected from the group comprising thermoforming, extrusion, deep drawing, pressing, bonding with thermoplastics (of the same or a different kind). Bonding with thermoplastics is preferably effected by injection molding, pressing or welding methods, with special methods such as overmolding or two-shot molding also being regarded as injection molding methods.

The present invention also relates to a device for carrying out a method as described above.

### BRIEF DESCRIPTION OF THE FIGURES

The invention will now be explained in detail by means of examples together with the drawings, in which:

FIG. 1 shows a schematic representation of a device for carrying out a method for production of a composite consisting of reinforcing materials and a thermoplastic polyamide matrix using anionically activated lactam polymerization; and

FIG. 2 shows an example of a device for impregnation and introduction into the heating unit.

### WAYS OF IMPLEMENTING THE INVENTION

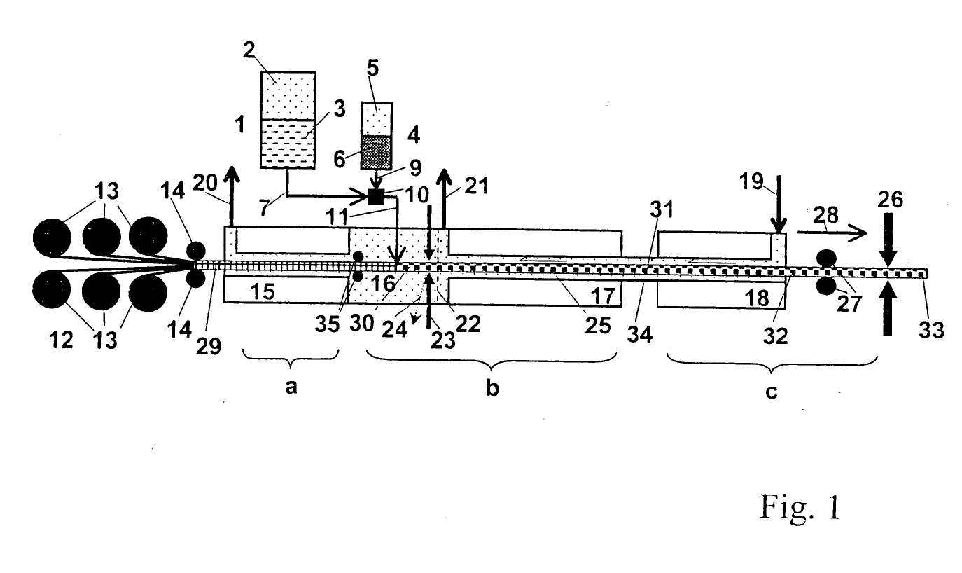

The present method will be illustrated with the aid of FIG. 1, which shows a schematic representation of a device for carrying out the method. In this case the method is a 1-pot method, i.e. a method in which the anionically activated lactam melt is produced by adding a liquid initiator to the lactam melt just before the impregnation.

From the left the reinforcing material 29 is fed in first of all. In the case illustrated here six webs of fiber rolls 13 are fed in and brought into the appropriate relative position by a pair of guide rollers 14. The reinforcing material 29 can, however, likewise be a plurality of filaments, rovings, etc., which are fed in off bobbins and channeled into the process in the desired arrangement. It is also possible, e.g. in the case of a woven or nonwoven textile reinforcing material, to feed this in only from one roll 13. As already mentioned at the outset, the reinforcing materials 29 can comprise a diverse range of structures and materials, such as for example glass fibers, carbon fibers, aramid fibers, high-temperature polyamide fibers, metal fibers or combinations of said fibers. This for example in the form of wound continuous filaments, yarns, staple fiber yarns, strands such as rovings, etc., which are then introduced into the process in a suitable arrangement via a plurality of bobbins 13 and guide rollers 14. Alternatively, or also additionally (combination of fibers and textiles), however, they can also be textile products formed from said fibers or from combinations of said fibers. This for example in the form of mats, needled felts, etc., or woven textiles. The method according to the invention is found to be particularly suitable for fibers or, in general, reinforcing materials which are brittle, friable and/or high-modulus (e.g. carbon fibers) and corresponding textile products where application of pressure during impregnation and/or shear in highly viscous melts (in a pultrusion mold) leads to considerable fiber damage (fiber breakage). If such friable fibers are in fact impregnated with a thermoplastic matrix in a pultrusion method, the high tensile forces due to the high viscosity of the melt lead to fiber breakages and thus to marked formation of the “bird's nests” mentioned at the outset, with fibers at the entrance to the pultrusion mold. Furthermore the fiber breakages lead to a deterioration in the quality of the finished composites. Through the rapid and pressure-free impregnation with a monomer melt and the free polymerization without application of force one obtains undamaged composites with intact fibers.

The reinforcing material 29 that is fed in is continuously channeled and conditioned in a first step a. In this operation the web or the strand is passed through a preheating unit 15, in which the reinforcing material 29 is both dried and preheated to the necessary temperature. In this operation it is heated to a temperature that is slightly above the temperature at which the activated lactam supplied as the melt does not solidify. The temperature of the reinforcing material at the time of impregnation, however, should not be already so high that significant polymerization of the lactam melt occurs before entry into the heating unit. It is usually found to be sufficient to set a temperature in the preheating unit 15 which lies in the range from 5 to 30 degrees Celsius above the melting point of the lactam, preferably a temperature is set which lies in the range from 10 to 20 degrees above this melting point. The heated and dried reinforcing material 29 is then, where appropriate, conveyed with the aid of tension-regulated feed rollers 35 into the area 16 for the impregnation. The feed rollers have the function of conveying especially sensitive textiles into the impregnation zone without tension and without warpage and of ensuring proper impregnation. In this context tension-regulated means that the drive of the feed rollers is regulated in such a way that the tensile stress in the textile web (or the strand) is low at the point of impregnation.

At the same time a lactam melt 3 is prepared in a lactam tank 1. It is heated to above its melting point, so that a low-viscosity melt is obtained. The lactam melt 3 can contain further usual additives, such as plasticizers, stabilizers, etc., and also fillers. At the same time a liquid initiator, which contains both the catalyst function and the activator function in dissolved form, is usually kept ready at room temperature. Particularly suitable for this purpose are liquid initiators such as described in EP 0791618 A1 and in EP 0872508 A1. Liquid initiators such as described in the applicant's Laid-Open Specifications DE 19961818 A1 and DE 19961819 A1 are also possible. The monomer melt 3 is conveyed via a heated monomer line 7, and the liquid initiator via an infeed 9 for the liquid initiator, to a mixer 10, where both components are thoroughly mixed with each other. In this operation the polymerization is controlled by the nature of the liquid initiator, the ratio of liquid initiator to lactam melt 3, and the reaction temperature. Static mixing elements, such as those of the Sulzer company, Winterthur (Switzerland), are particularly suitable as the mixer 10. The activated anionic lactam melt 11 obtained downstream of the mixer 10 is now conveyed directly into the area 16 for the impregnation and brought onto the dried and preheated reinforcing material that has been fed in. In this operation the temperature in the area 16 is advantageously above the melting point of the activated anionic lactam melt 11, and is in particular a temperature which corresponds to the temperature of the preheated reinforcing material 29, i.e. 10 to 20 degrees Celsius above the melting point of the lactam melt, for example. In this operation the low-viscosity melt impregnates and penetrates the continuously supplied reinforcing material 29 essentially completely. In the case of a textile reinforcing material in web form it may suffice simply to let the lactam melt drip onto the web, but normally the reinforcing material 29 has to be taken through an immersion bath, a channel, or through a veil of lactam melt. The impregnated reinforcing material 30 is then, where appropriate, sent through a skimming unit 23, to skim off excess matrix material 24, before the polymerization of the matrix has properly started and the viscosity is thus too high for skimming at a rapid production rate.

The impregnated reinforcing material 30, which is advantageously here conveyed at the latest in a channel which touches the impregnated reinforcing material 30 as little as possible (the (internal) wall of the channel is made of Teflon, for example), is conveyed into a heating unit 17 in which the temperature is one at which the activated anionic lactam polymerization takes place practically completely within the time during which the impregnated reinforcing material 30 is in the heating unit 17. The polymerization typically needs about one to two minutes for a practically complete cycle, and the required length of the heating unit 17 is calculated from the desired production rate and the time for the polymerization, which is adjusted in relation to the nature and amount of the initiator or activator added. So as not to have to make the heating unit unusually long (e.g. 40 meters) it is possible to reroute the impregnated reinforcing material several times in the heating unit with the aid of rollers (in this operation the rollers are advantageously made of Teflon), with the heating unit then being in the form of a chamber rather than a channel. In principle, however, the impregnated reinforcing material is conveyed largely without contact, especially in the initial part of the polymerization, so that as high a production rate as possible can be achieved. As an alternative to the free conveyance of the continuous textile product it is also possible, in the case of mats, which would tear under their own weight after the impregnation, to convey them through the heating unit on a base, e.g. a steel or Teflon conveyor belt.

Downstream of the heating unit the now polymerized composite 31 is conveyed into a cooling unit 18, in which the composite is cooled at least to a temperature which is below the setting temperature of the polyamide. Downstream of the cooling unit 18 the polymerized composite 32 is advanced by traction rollers 27 or crawlers and pulled through the process. The polymerized composite 32 can then be subjected to an assembly process 26.

Since lactam and polyamide melts are as a general rule susceptible to oxidation, those areas of the process in which the lactam or polyamide are in molten form are kept under an inert gas atmosphere 25 (e.g. nitrogen). Oxidation should be prevented in the heating unit 17, in particular. In addition, the inert gas (e.g. N₂) should be dry, so as not to partially use up the initiator with water. To this end the process line can be blanketed with dry nitrogen via a nitrogen feed 19. In order to be able additionally to take advantage of the cooling effect of the nitrogen used, the nitrogen can already be fed into the channel somewhat downstream of the heating unit 17 in the cooling unit 18, so that counterflow cooling in the area of the cooling unit or a counterflow in the heating unit is established. In this operation the nitrogen atmosphere can essentially only be maintained in the area of the heating unit 17 and the cooling unit 18, i.e. up to the boundary 22, but it is also possible to blanket the area 16 for the impregnation and the area 15 of the preheating unit for the reinforcing fibers with nitrogen, too, and not take the nitrogen away until downstream of the preheating unit 15 via a line 20. An inert gas atmosphere 2 should also be maintained over the lactam melt 3, just as a corresponding inert gas atmosphere 5 can be advantageous over the liquid initiator 6.

The finished composite can then be used either directly, without additional posttreatment, or it can be cut (made up) or wound onto a roller, and since it is a thermoplastic composite it can also be reworked into the final form in a thermal forming process in line or in a separate process. Typical composites contain fiber material in a proportion from 30 to 75% by weight. Examples of composites which can be used directly, without additional posttreatment, are (airtight) coated woven fabrics and bars or rods.

The method will be explained in greater detail by means of the following examples:

### EXAMPLE 1

Laurolactam pellets are melted under a nitrogen atmosphere at a temperature of 170 degrees Celsius in tank 1. A liquid initiator, such as described in Experiment 7 in DE 19961818 A1, is kept at room temperature in tank 4. According to Table 1 a) in DE 19961818 A1 the liquid initiator in Experiment No. 7 is a product of the reaction of dicyclohexyl-carbodiimide (DCC) with the protic compound Nylostab S-EED (Ny) and the base sodium methylate in the aprotic salvation medium N-octylpyrrolidone (NOP). In this operation liquid initiator 6 and lactam-12 melt are used in a ratio of 3.5:96.5% by weight. Liquid initiator 6 and lactam-12 melt are thoroughly mixed in the mixer 10 and brought onto a preheated and dried reinforcing material in a low-viscosity state (approximately like water).

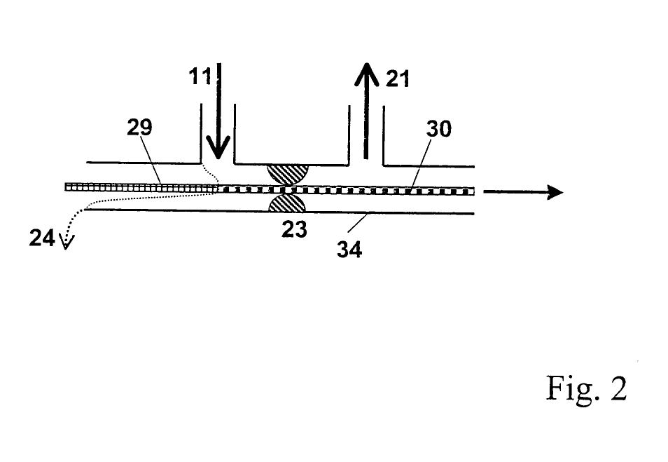

The reinforcing material, a 12 K (12,000 filaments) roving consisting of carbon fibers of the 5N21 type from the Tenax Fibers company, Wuppertal (Germany), is fed in from several bobbins, where appropriate, and preheated and dried in a preheating unit 15 at a temperature of 170 degrees Celsius. Downstream of the preheating unit 15 the fiber strand 29 is introduced into a Teflon channel 34, in which the line 11, through which the activated anionic lactam is supplied in a low-viscosity form for impregnation, ends after about 15 to 25 cm (cf. FIG. 2). Immediately downstream of the input of the activated anionic lactam in the process direction 28, the channel 34 exhibits a constriction or skimming point 23, so that to a certain extent in the section of the channel upstream of the constriction a dip bath forms, where the excess 24 of activated anionic lactam melt is removed at the entrance to the channel 34. The supply of lactam melt, however, can also be adjusted or throttled in such a way that no excess at all is removed any more. Downstream of the skimming point 23 the impregnated reinforcing material 30 is conveyed into the heating unit 17 essentially in freely suspended form, i.e. touching the channel as little as possible. Upstream of the inlet into the heating unit 17 the outlet 21 for nitrogen branches off from the channel, which at this point can be made either of glass or of Teflon. Since the constriction 23, which is in essence completely flooded with lactam melt, is located upstream of this outlet 21, in the process direction, there is in essence no uncontrolled escape of nitrogen through this constriction through the opening of the channel into which the reinforcing material is introduced. In addition, the nitrogen that has already been conveyed through the heating unit 17 leads to homogeneous and constant maintenance of a warm temperature or to an increase in the temperature to the reaction temperature of the impregnated reinforcing material between the entrance into the heating unit and the outlet 21 for the nitrogen, and accordingly it is advantageous to locate the outlet 21 as close as possible to the skimming point 23. This specific supply of the lactam melt via a channel or a hollow profile with a skimming point as shown in FIG. 2 is found to be advantageous in general, and not only in connection with this special embodiment.

Another possible way of impregnating the reinforcing material is to feed the reinforcing material 29 over rollers into a dip bath 11.

In this operation the process of impregnation in the area 16 is kept at 170 degrees Celsius. In the heating unit, through which the impregnated reinforcing material is passed, the temperature is around 250 degrees Celsius, the heating unit 17 is of such a length as to result in a residence time of around 2 min in the heating unit at the stated running speed—which with the type of initiator used is sufficient for complete polymerization of the matrix to polyamide-12. In an oven-type heating unit 17 in the experimental setup the strand 30 is conveyed in a Teflon channel, and only the interior of this channel is blanketed with nitrogen. Downstream of the heating unit 17 the channel protrudes for about a further 50 cm, and is blanketed with cold nitrogen via a T-piece in the opposite direction to the process direction 28. Downstream of this there is a withdrawal device in the form of two rollers 27, which pull the finished composite 33 with the desired speed.

The finished composite 33 does not usually have any precise cross-sectional shape yet and in many cases does not yet constitute the end product. Thanks to the thermoplastic matrix, however, it can be reworked directly in line or later thermoplastically to the final cross section.

### EXAMPLE 2

Caprolactam pellets are melted under a nitrogen atmosphere at a temperature above 80 degrees Celsius in tank 1. The same liquid initiator as in Example 1 is kept at room temperature in tank 4. In this operation liquid initiator 6 and lactam-6 melt are used in a ratio of 3.5:96.5% by weight. Liquid initiator 6 and lactam-6 melt are thoroughly mixed in the mixer 10 and brought onto a preheated and dried reinforcing material in a low-viscosity state (approximately like water). The reinforcing material, the same as in Example 1, is fed in from several bobbins, and preheated and dried in a preheating unit 15 at a temperature of 170 degrees Celsius. The remainder of the process is similar to Example 1, but the temperature in the heating unit through which the impregnated reinforcing material is passed is 230 degrees Celsius, i.e. somewhat lower than in Example 1, in order to keep the sublimation of caprolactam as low as possible.

For further reduction of the sublimation it is in principle also possible, in particular in the case of caprolactam, to operate below the melting point of the resultant polyamide-6 in the heating unit, because even at 200 degrees Celsius the polymerization rate is sufficient in many cases.

### LIST OF DESIGNATIONS

1 lactam tank
2 nitrogen atmosphere over lactam
3 lactam, monomer melt
4 liquid initiator tank
5 nitrogen atmosphere over liquid initiator
6 liquid initiator
7 monomer feed (heated)
9 feed for liquid initiator
10 mixer
11 feed for the activated monomer mixture, lactam melt activated for anionic polymerization
12 feed for the reinforcement fibers
13 fiber roll (bobbin) with semifinished product reinforcement
14 pair of guide rollers
15 preheating unit for the reinforcement fibers
16 impregnation unit
17 heating unit
18 cooling unit
19 nitrogen feed
20 nitrogen outlet
21 alternative nitrogen outlet
22 alternative boundary of the nitrogen area
23 skimming unit
24 removal of excess matrix material
25 nitrogen atmosphere
26 making-up unit
27 withdrawal device (traction rollers)
28 process direction
29 reinforcing fibers
30 impregnated reinforcing fibers
31 polymerized composite (hot)
32 polymerized composite (cold)
33 composite
34 channel
35 feed rollers
a preparation of matrix and fibers
b impregnation and polymerization
c cooling and making up

1. A method for the production of a composite (33) from reinforcing materials (29) and a thermoplastic polyamide,
characterized in that
the reinforcing materials supplied (29) are impregnated with a lactam melt (11) activated for anionic polymerization, at a temperature at which the activated lactam melt (11) does not significantly polymerize yet,
the impregnated reinforcing material (30) is heated and polymerized in a heating unit (17) without going through a heated mold, with the impregnated reinforcing material (30) being passed through the heating unit (17) without any significant contact,
the resultant hot polymerized composite (31) is cooled in a cooling unit (18),
where the lactam melt (11) activated for anionic polymerization is produced by first melting the lactam or the mixture of lactams to form a monomer melt (3), and mixing a liquid initiator (6) with the monomer melt (3) essentially just before the process of impregnation of the reinforcing material (29), which liquid initiator (6) simultaneously contains the activator function and the catalyst function in solution.

2. The method as claimed in claim 1, characterized in that the monomer melt (3) activated for anionic polymerization is essentially a melt consisting of aliphatic lactam, particularly preferably of butyrolactam, valerolactam, caprolactam, enantholactam or laurolactam, or of a mixture of said lactams.

3. The method as claimed in one of the preceding claims, characterized in that the liquid initiator (6) is stable in storage and liquid at room temperature.

4. The method as claimed in one of the preceding claims, characterized in that the catalyst function of the liquid initiator (6) is assumed by a catalyst in the form of an alkali metal, tetraalkylammonium or alkaline earth metal lactamate, in particular of a sodium or potassium lactamate in dissolved form, with lactamates having 5 to 13 ring members, preferably lactamates having 5 to 7 ring members, and particularly preferably caprolactamate, being used.

5. The method as claimed in one of the preceding claims, characterized in that the activator function of the liquid initiator (6) is assumed by an activator activating the anionic polymerization in the form of an acyllactam, of a carbodiimide, of a polycarbodiimide, of a monoisocyanate, and/or of a diisocyanate, and/or of a mixture of these activators, preferably masked with lactam or hydroxy-fatty alkyloxazolines, in dissolved form.

6. The method as claimed in one of the preceding claims, characterized in that the catalyst function and activator function of the liquid initiator (6) is assumed by at least one initiator component in dissolved form, which initiator component in a free or partially to completely inherent way exhibits the necessary structural elements to form both the catalyst and the activator on contact with lactam.

7. The method as claimed in claim 6, characterized in that the initiator component is a product of the reaction of isocyanate and/or of carbodiimide with a protic compound and a base in an aprotic solvation medium.

8. The method as claimed in one of the preceding claims, characterized in that the liquid initiator (6) is mixed with the monomer melt (3) in an amount from 1 to 10% by weight, in particular from 2 to 4% by weight, relative to 100% activated anionic lactam melt (11).

9. The method as claimed in one of the preceding claims, characterized in that the lactam melt (11) activated for anionic polymerization additionally contains fillers or other additives.

10. The method as claimed in one of the preceding claims, characterized in that the reinforcing materials (29) are glass fibers, carbon fibers, aramid fibers, high-temperature polyamide fibers, metal fibers or combinations of said fibers, in particular in the form of continuous filaments, yarns, staple fiber yarns, strands, rovings, and/or textile products formed from said fibers or from combinations of said fibers, such as knitted fabrics, woven fabrics, braids, stitched fabrics, or nonwoven fabrics.

11. The method as claimed in one of the preceding claims, characterized in that the reinforcing material (29) is dried and/or preheated before the impregnation, the preheating being in particular to a temperature which lies above the melting point of the lactam melt (11) activated for anionic polymerization.

12. The method as claimed in one of the preceding claims, characterized in that the reinforcing material (29) is continuously supplied in the form of one or more webs or filaments, impregnated with the lactam melt (11) activated for anionic polymerization, passed through the heating unit (17) and the cooling unit (18), and drawn off downstream of the cooling unit (18) by withdrawal devices (27).

13. The method as claimed in claim 12, characterized in that the composite (33) is conveyed through the process at a speed of at least 1 m/min, in particular of at least 5 m/min, particularly preferably at over 10 m/min.

14. The method as claimed in one of the preceding claims, characterized in that the impregnated reinforcing material (30) is conveyed under a protective gas atmosphere, in particular under a dry nitrogen atmosphere, at least in the heating unit (17), and in that in a particularly preferred embodiment in addition the area (15) in which the reinforcing material (29) is heated up or dried, the area (16) in which the impregnation takes place, and the tanks (1, 4) in which the lactam melt(s) and where appropriate also the liquid initiator (6) and the cooling unit (18) are kept, are kept under a protective gas atmosphere.

15. The method as claimed in claim 14, characterized in that the protective gas is conveyed in counterflow to the process direction (28) in the area (15) where the reinforcing material (29) is heated up, in the impregnation area (16), and in particular in the area (17) of the heating unit and in the area of the cooling unit (18), in particular in a coherent manner between the areas (15-18).

16. The method as claimed in one of the preceding claims, characterized in that the heating unit (17) and/or the cooling unit (18) is in the form of a channel, which channel is adapted to the cross section of the impregnated reinforcing material (30) in such a way that sufficient free space on all sides is left between the impregnated reinforcing material (30) and the walls of the channel in order to pass the impregnated reinforcing material (30) through the channel without any significant contact, with the channel particularly preferably being blanketed with protective gas as per either of claims 14 or 15.

17. The method as claimed in one of the preceding claims, characterized in that the impregnated reinforcing material (30) goes past a skimming point (23) at which excess lactam is skimmed off, after the impregnation and essentially before entry into the heating unit (17), in the process direction (28).

18. The method as claimed in one of the preceding claims, characterized in that the lactam used is laurolactam, this is melted at a temperature of over 151 degrees Celsius and a liquid initiator (6) kept at room temperature is added to it, and it is mixed with the lactam melt (11) activated for anionic polymerization, in that continuously supplied reinforcing material (29), preheated to around 170 degrees Celsius, is impregnated at a temperature of around 170 degrees Celsius, is completely polymerized freely and without contact in the heating unit (17) at a temperature in the range from 200 to 250 degrees Celsius for a time from 30 sec to five minutes, in particular for a time from 1 to 3 minutes, and is then cooled in the cooling unit (18) to a temperature of less than 150 degrees Celsius.

19. The method as claimed in one of claims 1 to 18, characterized in that the lactam used is caprolactam, this is melted at a temperature of over 69 degrees Celsius and a liquid initiator (6) kept at room temperature is added to it, and it is mixed with the lactam melt (11) activated for anionic polymerization, in that continuously supplied reinforcing material (29), preheated to around 170 degrees Celsius, is impregnated at a temperature of around 170 degrees Celsius, is completely polymerized freely and without contact in the heating unit (17) at a temperature in the range from 230 to 240 degrees Celsius, or also below the melting point of polycaprolactam, for a time from 30 sec to five minutes, in particular for a time from 1 to 3 minutes, and is then cooled in the cooling unit (18) to a temperature of less than 200 degrees Celsius.
